(19) United States
(12) Patent Application Publication
(10) Pub. No.: US 2016/0110070 A1
(43) Pub. Date: Apr. 21, 2016

(54) PHOTO COLLECTION DISPLAY METHOD AND APPARATUS

(71) Applicant: Tencent Technology (Shenzhen) Company Limited, Shenzhen (CN)

(72) Inventors: Qiang FU, Shenzhen (CN); Hao WU, Shenzhen (CN); Xiaochuan XU, Shenzhen (CN); Aidun ZHANG, Shenzhen (CN); Youkun HUANG, Shenzhen (CN); Xinxing LI, Shenzhen (CN); Yutao LI, Shenzhen (CN); Xin LIU, Shenzhen (CN); Jin CUI, Shenzhen (CN); Linwei CHEN, Shenzhen (CN); Jingjing LIU, Shenzhen (CN)

(21) Appl. No.: 14/978,373

(22) Filed: Dec. 22, 2015

Related U.S. Application Data
(63) Continuation of application No. PCT/CN2015/074965, filed on Mar. 24, 2015.

(30) Foreign Application Priority Data
Mar. 26, 2014 (CN) 201410118115.0

(51) Int. Cl. G06F 3/0484; G06T 1/00; G06F 3/0482

(52) U.S. Cl. CPC G06F 3/04842; G06F 3/0482; G06T 1/0007

(57) ABSTRACT

A photo collection display method and apparatus are disclosed. The method includes: acquiring photo selection information, the photo selection information comprising: a birth date of a figure in a photo; reading photo information of each photo in a photo collection, the photo information comprising: a photo shooting time, the photo collection recording more than one photo; calculating a difference between a photo shooting time and the birth date of the figure in each photo, to obtain a sorting date of each photo; creating a timeline comprising time points; matching the sorting date with a time point in the timeline, to obtain a link relationship between the sorting date and the corresponding time point in the timeline; and displaying, after one time point in the timeline is triggered, a corresponding photo of the photo collection in a predetermined position of the timeline according to the link relationship.

### CROSS REFERENCE TO RELATED APPLICATION

This application is a continuation of International Application No. PCT/CN2015/074965, filed on Mar. 24, 2015, which claims priority to Chinese patent application No. 201410118115.0, filed on Mar. 26, 2014, the content of which are incorporated herein by reference in their entirety.

### FIELD OF THE TECHNOLOGY

The present disclosure relates to the field of computer data processing, and in particular, to a photo collection display method and apparatus.

### BACKGROUND OF THE DISCLOSURE

In the existing technology, social platforms have become an effective tool for a user to present various information, which help people to understand the information transmitted by the user, so that information transmission and communication are further performed, thereby achieving an objective of performing close social interaction activities.

Currently, a social platform can provide a function of creating a user photo album and a user can save a photo to the social platform. For example, a user can save all photos of a child after birth in a photo album created on a social platform, to form a photo collection. To present photos in the photo collection more directly, the user needs to manually arrange photos irregularly or regularly.

For example, the user uploads all the photos of the child after birth to a social platform, to form a photo collection; in this process, if the user wants to arrange the photos of the child from birth to various growth stages, the user may manually put photos of a same growth stage to a same photo album. When the user opens the photo album to browse the photos, the photos are arranged according to uploading times or shooting times. The user can only browse a single photo album each time, and photos in the photo album are unorganized, and therefore, the user cannot directly view detailed information of photos in each photo album.

Currently, no effective solution has yet been put forward to solve the foregoing problem in the related technology of disordered display and poor user experience that are caused by unorganized photos in a photo album provided by a social platform.

### SUMMARY

Embodiments of the present invention provide a photo collection display method and apparatus, so as to at least solve the technical problem in the related technology of disordered display and poor user experience that are caused by unorganized photos in a photo album provided by a social platform.

According to an aspect of the embodiments of the present invention, a photo collection display method is provided, including: acquiring photo selection information, the photo selection information comprising: a birth date of a figure in a photo; reading photo information of each photo in a photo collection, the photo information comprising: a photo shooting time, the photo collection recording more than one photo; calculating a difference between a photo shooting time and the birth date of the figure in each photo, to obtain a sorting date of each photo; creating a timeline comprising time points; matching the sorting date with a time point in the timeline, to obtain a link relationship between the sorting date and the corresponding time point in the timeline; and displaying, after one time point in the timeline is triggered, a corresponding photo of the photo collection in a predetermined position of the timeline according to the link relationship.

According to another aspect of the embodiments of the present invention, a photo collection display apparatus is further provided, including: an acquisition module, configured to acquire photo selection information, the photo selection information comprising: a birth date of a figure in a photo; a read module, configured to read photo information of each photo in a photo collection, the photo information comprising: a photo shooting time, the photo collection recording more than one photo; a processing module, configured to calculate a difference between a photo shooting time and the birth date of the figure in each photo, to obtain a sorting date of each photo; and a display processing module, configured to display, in a timeline, the photos in the photo collection according to the sorting dates, the display processing module comprising a matching unit and a display unit:
the matching unit being configured to match the sorting date with a time point in the timeline, to obtain a link relationship between the sorting date and the corresponding time point in the timeline; and
the display unit being configured to display, in a predetermined position in the timeline, the photos in the photo collection according to the link relationship after the time point in the timeline is triggered.

A non-transitory computer readable storage medium having stored therein one or more instructions, which, when executed by a computing device, cause the computing device to: acquire photo selection information, the photo selection information comprising: a birth date of a figure in a photo; read photo information of each photo in a photo collection, the photo information comprising: a photo shooting time, the photo collection recording more than one photo; calculate a difference between a photo shooting time and the birth date of the figure in each photo, to obtain a sorting date of each photo; match the sorting date with a time point in the timeline, to obtain a link relationship between the sorting date and the corresponding time point in the timeline; and display, after one time point in the timeline is triggered, a corresponding photo of the photo collection in a predetermined position of the timeline according to the link relationship.

In the embodiments of the present invention, photo selection information is acquired, the photo selection information including: a birth date of a figure in a photo; photo information of each photo in a photo collection is read, the photo information including: a photo shooting time; a difference between the birth date of the figure in the photo and the photo shooting time of each photo is calculated, to obtain a sorting date of each photo; and the photos in the photo collection are displayed in a timeline according to the sorting dates, and a condition for arranging the photos in the photo collection is acquired by using the birth date of the figure in the photo and the photo shooting time of each photo, that is, a difference between a photo shooting time and the birth date of the figure in each photo, to obtain a sorting date of each photo is calculated, to obtain the sorting date of each photo, where the sorting date may be used to indicate the age of the figure in the photo when the photo was shot, or may be used to determine a display order of the photo; in this case, a system displays the photos in a timeline by using the sorting dates obtained through calculation, that is, it is defined that each photo is automatically classified according to the sorting date, so that an objective is achieved that when a user views the photo collection, the photos displayed in the timeline can provide the user with a function of viewing the photos and the photo shooting times in batches, and the user can learn a corresponding age stage of the figure in the photo when the photo was shot, that is, a function of automatic management and classification for the figure in the photo is provided. Therefore, the photos are automatically classified according to the photo shooting times, and the classified photos are displayed in a timeline, thereby solving the technical problem in the related technology of disordered display and poor user experience that are caused by unorganized photos in a photo album provided by a social platform, and achieving effects of automatic classification of a photo collection and automatic display of photos of a figure in a photo at each age stage.

### BRIEF DESCRIPTION OF THE DRAWINGS

The accompanying drawings described herein are used for further understanding the present disclosure and are a part of this application. Exemplary embodiments of the present invention and descriptions thereof are used to explain the present disclosure, but are not intended to improperly limit the present disclosure. In the accompanying drawings:

FIG. 1 is a schematic structural diagram of a photo collection display apparatus according to Embodiment 1 of the present invention;

FIG. 2 is a schematic picture diagram of a display result of a photo collection according to an embodiment of the present invention;

FIG. 3 is a schematic structural diagram of an optional photo collection display apparatus according to Embodiment 1 of the present invention;

FIG. 4 is a schematic structural diagram of another optional photo collection display apparatus according to Embodiment 1 of the present invention;

FIG. 5 is a schematic structural diagram of still another optional photo collection display apparatus according to Embodiment 1 of the present invention;

FIG. 6 is a schematic structural diagram of yet another optional photo collection display apparatus according to Embodiment 1 of the present invention;

FIG. 7 is a schematic flowchart of a photo collection display method according to Embodiment 1 of the present invention;

FIG. 8 is a detailed flowchart of an optional photo collection display method according to Embodiment 1 of the present invention;

FIG. 9 is a detailed flowchart of another optional photo collection display method according to Embodiment 1 of the present invention;

FIG. 10 is a detailed flowchart of still another optional photo collection display method according to Embodiment 1 of the present invention;

FIG. 11 is a detailed flowchart of yet another optional photo collection display method according to Embodiment 1 of the present invention; and

FIG. 12 is a detailed flowchart of yet another optional photo collection display method according to Embodiment 1 of the present invention.

### DESCRIPTION OF EMBODIMENTS

It should be noted that the embodiments in this application and features in the embodiments can be combined with each other in the case of no conflict. The present disclosure is described in detail below with reference to the accompanying drawings and the embodiments.

In order for a person skilled in the art to better understand the solutions of the present disclosure, the following clearly and completely describes the technical solutions in the embodiments of the present invention with reference to the accompanying drawings in the embodiments of the present invention. Apparently, the described embodiments are merely some rather than all of the embodiments of the present invention. All other embodiments obtained by a person of ordinary skill in the art based on the embodiments of the present invention without creative efforts shall fall within the protection scope of the present disclosure.

It should be noted that terms in the specification and claims of the present disclosure and the foregoing accompanying drawings such as “first” and “second” are used to differentiate similar objects, and are not necessarily used to describe a particular sequence or an order. It should be understood that data used in this way is interchangeable in a proper case, so that the embodiments of the present invention described herein can be implemented in an order except those shown in the figures or described herein. In addition, terms “include” and “have” and any variation thereof are intended to cover a non-exclusive inclusion. For example, a process, method, system, product, or device that includes a series of steps or units is not limited to those steps or units that are clearly listed, but may include other steps or units that are not clearly listed or are inherent for the process, method, product, or device.

### Embodiment 1

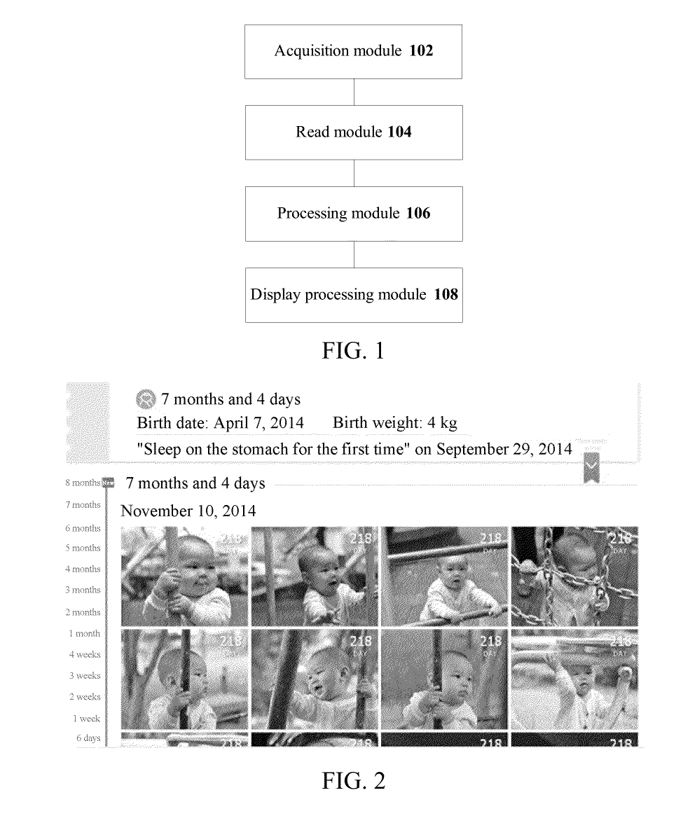

Before the embodiments of this application are further detailed, a proper computing apparatus structure that can be used to implement the principle of this application is described with reference to FIG. 1. In the description below, the embodiments of this application are described with reference to symbols of actions and operations that are performed by one or more computers, unless indicated otherwise. As can be understood from this, such actions and operations, which are at times referred to as being computer-executed, include the manipulation by a processing unit of a computer of electrical signals representing data in a structured form. This manipulation transforms the data or maintains it at locations in the memory system of the computer, which reconfigures or otherwise alters the operation of the computer in a manner well understood by a person skilled in the art. The data structures where data is maintained are physical locations of the memory that have particular properties defined by the format of the data. However, while this application is described in the foregoing context, it is not meant to be limiting as a person skilled in the art will understand that various aspects of the actions and operations described hereinafter may also be implemented in hardware.

In a most basic configuration thereof, FIG. 1 is a schematic structural diagram of a photo collection display apparatus according to Embodiment 1 of the present invention. For the purpose of description, the drawn architecture is only an example of a proper environment, and is not intended to limit the use range or function of this application. In addition, the computer system should not be construed as relying on or requiring any component or any combination thereof shown in FIG. 1.

As shown in FIG. 1, the photo collection display apparatus may include: an acquisition module 102, a read module 104, a processing module 106, and a display processing module 108, where
the acquisition module 102 is configured to acquire photo selection information, the photo selection information including: a birth date of a figure in a photo; the read module 104 is configured to read photo information of each photo in a photo collection, the photo information including: a photo shooting time; the processing module 106 is configured to calculate a difference between a photo shooting time and the birth date of the figure in each photo, to obtain a sorting date of each photo; and the display processing module 108 is configured to display, in a timeline, the photos in the photo collection according to the sorting dates, the display processing module including a matching unit and a display unit: the matching unit being configured to match the sorting date with a time point in the timeline, to obtain a link relationship between the sorting date and the corresponding time point in the timeline; and the display unit being configured to display, in a predetermined position in the timeline, the photos in the photo collection according to the link relationship after the time point in the timeline is triggered.

In the foregoing embodiment of this application, a condition for arranging the photos in the photo collection is acquired by using the birth date of the figure in the photo and the photo shooting time of each photo, that is, a difference between the birth date of the figure in the photo and the photo shooting time of each photo is calculated, to obtain the sorting date of each photo, where the sorting date may be used to indicate the age of the figure in the photo when the photo was shot, or may be used to determine a display order of the photo; in this case, a system displays the photos in a timeline by using the sorting dates obtained through calculation, that is, it is defined that each photo is automatically classified according to the sorting date. Therefore, in the Embodiment 1 of this application, the photos are automatically classified according to the photo shooting times, and the classified photos are displayed in a timeline, so that when a user views the photo collection, the photos displayed in the timeline can provide the user with a function of viewing the photos and the photo shooting times in batches, and the user can learn a corresponding age stage of the figure in the photo when the photo was shot, that is, a function of automatic management and classification for the figure in the photo is provided, thereby solving the technical problem in the related technology of disordered display and poor user experience that are caused by unorganized photos in a photo album provided by a social platform, and achieving effects of automatic classification of a photo collection and automatic display of photos of a figure in a photo at each age stage.

Specifically, the foregoing embodiment is described in detail by using an example in which a parent-child album on a social platform is used as a photo collection. The parent-child album may be a photo collection used to specially store photos of a same person from birth to various growth stages, and a figure in a photo in a parent-child album may be referred to as an album baby. A user can set a birth date of an album baby corresponding to a parent-child album by using an input interface or a selection control; after a photo shooting time of each parent-child photo in the parent-child album is read, a sorting date of each photo in the current parent-child album is acquired by calculating a difference between the birth date of the album baby and the photo shooting time of each parent-child photo, and finally, the photos in the parent-child album are displayed in a timeline according to the sorting dates, so that all the photos in the parent-child album are automatically classified and displayed according to the photo shooting times of the parent-child photos, that is, classified photos of the baby at each age stage in the parent-child album are automatically presented in the timeline.

Herein, it should be noted that the photo selection information in the acquisition module 102 may be information input by a user by means of an input window or a selection window, which at least includes the birth date of the figure in the photo in the current photo collection (for example, in FIG. 2, a birth date of a baby, that is Apr. 7, 2014 is input by means of window input or selection input). In addition, the photo information in the read module 104 may be a file acquired by a camera according to set parameters when the camera shoots a figure in a photo, where the photo shooting time is a time at which a digital photo is shot; the digital camera shoots a photo, records a shooting time at that time, and saves the shooting time in EXIF information of the photo, where the exchangeable image file (EXIF) is photo information set by the digital camera for the photo, which can record attribute information and a shooting time of the digital photo. Inserted into a data header of a photo in a JPEG format is information of a digital photo, which includes various shooting conditions, such as an aperture, a shutter, white balance, ISO, a focal length, and date and time during photo shooting, a camera brand, type, and color code, a sound recorded during photo shooting, a global positioning system (GPS), a thumbnail, and the like.

Herein, it should be further noted that a sorting date, of a photo album whose shooting date is Nov. 10, 2014, that is obtained by the processing module 106 is 7 months and 4 days, and therefore, the display processing module 108 displays the foregoing photo collection in a position indicating 7 months and 4 days in a timeline, and each photo displays information of the baby, such as 218 days. Herein, the timeline used by the display processing module 108 in the execution process is a number axis that may have a time scale, and time points in the number axis may be marked in any one or more units of day, week, month, and year. For example, as shown in FIG. 2, the photos in the parent-child album are displayed in the vertical timeline, and time points displayed in the timeline may include: 6 days, 1 week, 2 months, and the like. In addition, the timeline herein may also be in another form and another display position. For example, the timeline may be displayed in a form of a calendar, and when a user selects an identifier of any day, week, month, or year in the calendar, a corresponding photo collection may be displayed.

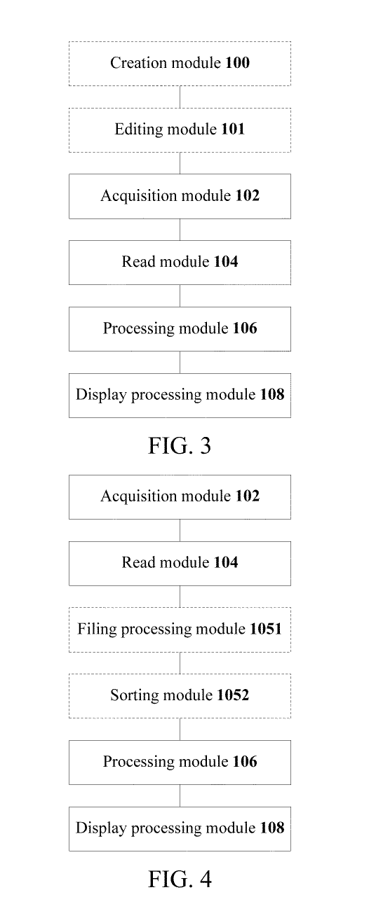

In the foregoing embodiment of this application, as shown in FIG. 3, before acquiring photo selection information by using the acquisition module 102, the foregoing apparatus may further include: a creation module 100 and an editing module 101, where
the creation module 100 is configured to create the photo collection; and the editing module 101 is configured to input the photo selection information by using an input interface after the photo collection is successfully created, where the photo selection information further includes: a name and feature information of the figure in the photo.

Specifically, an example in which a parent-child album on a social platform is used as a photo collection is used, and in the foregoing solution, the user creates a parent-child album on a social platform by using the creation module 100, where the parent-child album is used to store photos related to the album baby.

Optionally, after the parent-child album is created, the user can edit the parent-child album, and input photo selection information of the parent-child album by using the editing module 101. For example, the user can select a birth date and time of the album baby (that is, the figure in the photo), and input information of the album baby, such as a birth weight (such as 4 kg set in FIG. 2), a name, and a blood type.

It should be noted herein that the user can upload related photos of the baby to the parent-child album at any time, that is, update content of the photo collection. In addition, when the user uploads a parent-child photo, the system can extract a photo shooting time of the newly uploaded photo from EXIF information of the photo and save the photo shooting time.

In the foregoing embodiment of this application, as shown in FIG. 4, before comparing the birth date of the figure in the photo with a photo shooting time of each photo by using the processing module 106, to obtain a sorting date of each photo, the foregoing apparatus may further include: a filing processing module 1051 and a sorting module 1052, where the filing processing module 1051 is configured to file the photo collection in a time unit of day, to acquire a set of photos shot each day; and the sorting module 1052 is configured to sort the photos in each photo collection according to the photo shooting times, to obtain multiple photo volumes.

Specifically, an example in which a parent-child album on a social platform is used as a photo collection is still used. By using the filing processing module 1051 and the sorting module 1052, it is achieved that photos in the parent-child album are filed according to extracted photo shooting times, a photo collection is arranged in a unit of day, and photos in the photo collection are arranged according to the photo shooting times, thereby obtaining multiple photo volumes. In this case, shooting times of photos saved in each photo volume belong to a same day.

It should be noted herein that in this application, the photo collection may further be filed in a unit of month, week, quarter, or year as needed, to obtain photo collections that are obtained after being filed according to different time units, which is not limited in the present disclosure.

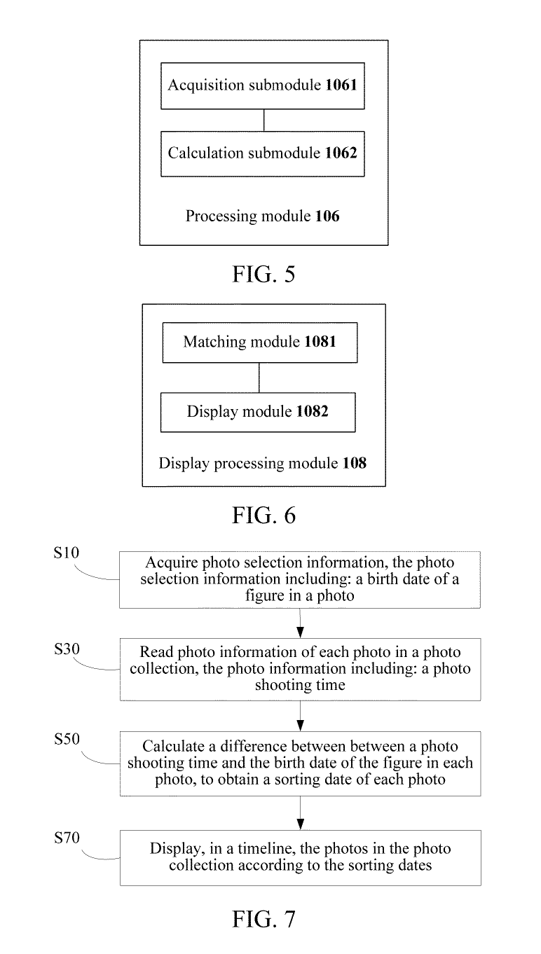

In the foregoing embodiment of this application, as shown in FIG. 5, the processing module 106 that is configured to calculate a difference between the birth date of the figure in the photo and a photo shooting time of each photo, to obtain a sorting date of each photo may include: an acquisition submodule 1061 and a calculation submodule 1062, where
the acquisition submodule 1061 is configured to acquire a photo volume shooting time corresponding to each photo volume, where photo shooting times of all photos in the photo volume are rounded in a unit of day, to obtain the photo volume shooting time; and the calculation submodule 1062 is configured to calculate a difference between each photo volume shooting time and the birth date of the figure in the photo, to obtain a sorting date of the photo volume.

Specifically, in the implementation process of the acquisition submodule 1061, the photo volume shooting time may be processed in a unit of day; a corresponding photo volume shooting time may also be acquired in a unit of week, month, quarter, or year. For example, a current photo volume includes three photos, and photo shooting times of the photos are separately: Oct. 1, 2014 8:01, Oct. 1, 2014 8:10, and Oct. 1, 2014 8:26; then the photo shooting time of each photo may be rounded in the unit of day, and a shooting time of the current photo volume is Oct. 1, 2014. As can be learned from this, photo volumes of a photo collection that have different numbers and content may be obtained in different time units, and a photo volume shooting time of each photo volume is acquired, which are not limited in the present disclosure.

Specifically, as described above, in an implementation process of the calculation submodule 1062, in addition to in a unit of day, the sorting date of the photo volume may also be in a unit of week, month, quarter, or year, so as to correspond to different time points in the timeline.

In the foregoing embodiment of this application, as shown in FIG. 6, the display processing module 108 that displays, in the timeline, the photos in the photo collection according to the sorting dates may include: a matching module 1081 and a display module 1082, where
the matching module 1081 is configured to match the sorting date with a time point in the timeline, to obtain a link relationship between the sorting date and the corresponding time point in the timeline; and the display module 1082 is configured to display, in the timeline, the photos in the photo collection according to the link relationship after the time point in the timeline is triggered.

Specifically, an example in which a parent-child album on a social platform is used as a photo collection is still used. In this application, in an implementation process of the matching module 1081 and the display module 1082, a difference between birth date information of a baby and a photo shooting time may also be calculated to obtain a sorting date of a photo, so that a correspondence between the sorting date and a time point of the baby photo in a timeline is determined, and photo information of the baby from birth to various stages is presented according to the obtained correspondence.

Further, age information, birth weight information, and childhood name information of the baby may also be presented.

In the foregoing embodiment of this application, after the photos in the photo collection are displayed in the timeline according to the sorting dates, the following implementation process may further be performed in the foregoing solutions:

First, open a photo corresponding to any time point in the timeline.

Second, input event information corresponding to the photo, the event information including: event content and an event time.

Specifically, an example in which a parent-child album on a social platform is used as a photo collection is still used. In the foregoing solution, it is achieved that after a user opens a parent-child album corresponding to any time point in the timeline, and photo information and ages of a baby after birth at various stages are presented, the user can input, into the opened parent-child album, an event in a growth process of the baby for each photo. For example, the user records information such as event content of the baby, a time when the event occurred, and thoughts when the event occurred. Therefore, after the event information corresponding to the photo is saved, when a parent-child album is opened subsequently, in addition to presenting photos shot within a corresponding time, the system may further present event content of all photos in the parent-child album, and present times when the events occurred.

As can be learned from this, in the foregoing solutions of this application, it is achieved that a user creates and presents an event for a photo displayed in a timeline, to record an important event of a figure in the photo occurred at a particular time, such as an event and thought when a baby was born, one-month old, or one-year old, or may be another event deemed to be meaningful. The event is edited based on a particular time corresponding to the figure in the photo in the timeline, so that description of the event, a time when the event occurred, the age of the baby when the event occurred, and the photo shot when the event occurred can be collectively presented according to event description of the baby input by the user, and input and presentation of a childhood name and a birth weight of the baby of the parent-child album that are edited by the user can also be provided.

To sum up, the present disclosure provides a photo collection display apparatus, which can automatically classify and sort photos according to times when a user shot the photos and birth dates of figures in the photos, and present photos of the figures in the photos at various age stages; provide an interface through which the user can turn to an event (major event) of the figure in the photo that occurred at a particular time, and display the event of the figure in the photo and a scenario of the photo when the event occurred; and present a childhood name and birth weight of the figure in the photo according to input of the user. The present disclosure provides a method for managing photos of a user from birth to various growth stages, which is used for the user to create a parent-child album, and manage and view photos of growth of a figure in a photo (a baby) at various age stages and corresponding major events.

In the foregoing embodiment, not only can a newly created photo collection be processed, but also an existing photo album can be converted into a parent-child album. It should be further noted that the foregoing method embodiment is not limitedly applied to a parent-child photo collection on an Internet social platform, but also can be applied to filing and arrangement of any Internet photos or any local photos on a terminal, and any type of photo collection, such a travel photo collection, or a documentary photo collection.

### Embodiment 2

According to this embodiment of the present invention, a method embodiment for implementing the foregoing apparatus embodiment is further provided. It should be noted that steps shown in the flowchart of the accompanying drawings may be performed in a computer system of a set of computer-executable instructions, and although a logic sequence is shown in the flowchart, in some cases, the shown or described steps may be performed in an order different from the sequence herein.

FIG. 7 is a schematic flowchart of a photo collection display method according to Embodiment 1 of the present invention.

As shown in FIG. 7, the photo collection display method may include the following steps:

Step S10: Acquire photo selection information, the photo selection information including: a birth date of a figure in a photo.

Specifically, the photo selection information in the step may be information input by a user by means of an input window or a selection window, which at least includes the birth date of the figure in the photo in the current photo collection (for example, in FIG. 2, a birth date of a baby, that is Apr. 7, 2014 is input by means of window input or selection input).

Step S30: Read photo information of each photo in a photo collection, the photo information including: a photo shooting time.

Specifically, the photo information in the step may be a file acquired by a camera according to set parameters when the camera shoots a figure in a photo, where the photo shooting time is a time at which a digital photo is shot; the digital camera shoots a photo, records a shooting time at that time, and saves the shooting time in EXIF information of the photo, where the EXIF is photo information set by the digital camera for the photo, which can record attribute information and a shooting time of the digital photo. Inserted into a data header of a photo in a JPEG format is information of a digital photo, which includes various shooting conditions, such as an aperture, a shutter, white balance, ISO, a focal length, and date and time during photo shooting, a camera brand, type, and color code, a sound recorded during photo shooting, a GPS, a thumbnail, and the like.

Step S50: Calculate a difference between a photo shooting time and the birth date of the figure in each photo, to obtain a sorting date of each photo. For example, as shown in FIG. 2, when a birth date of a baby is Apr. 7, 2014, a sorting date of a photo album whose shooting date is Nov. 10, 2014 may be 7 months and 4 days, and therefore, the foregoing photo collection is displayed in a position indicating 7 months and 4 days in a timeline, and each photo displays information of the baby, such as 218 days.

Step S70: Display, after one time point in the timeline is triggered, a corresponding photo of the photo collection in a predetermined position of the timeline according to the link relationship.

Specifically, the timeline in the step is a number axis that may have a time scale, and time points in the number axis may be marked in any one or more units of day, week, month, and year. For example, as shown in FIG. 2, the photos in the parent-child album are displayed in the vertical timeline, and time points displayed in the timeline may include: 6 days, 1 week, 2 months, and the like. In addition, the timeline herein may also be in another form and another display position. For example, the timeline may be displayed in a form of a calendar, and when a user selects an identifier of any day, week, month, or year in the calendar, a corresponding photo collection may be displayed.

In the foregoing embodiment of this application, a condition for arranging the photos in the photo collection is acquired by using the birth date of the figure in the photo and the photo shooting time of each photo, that is, a difference between the birth date of the figure in the photo and the photo shooting time of each photo is calculated, to obtain the sorting date of each photo, where the sorting date may be used to indicate the age of the figure in the photo when the photo was shot, or may be used to determine a display order of the photo; in this case, a system displays the photos in a timeline by using the sorting dates obtained through calculation, that is, it is defined that each photo is automatically classified according to the sorting date. Therefore, in the embodiment of this application, the photos are automatically classified according to the photo shooting times, and the classified photos are displayed in a timeline, so that when a user views the photo collection, the photos displayed in the timeline can provide the user with a function of viewing the photos and the photo shooting times in batches, and the user can learn a corresponding age stage of the figure in the photo when the photo was shot, that is, a function of automatic management and classification for the figure in the photo is provided, thereby solving the technical problem in the related technology of disordered display and poor user experience that are caused by unorganized photos in a photo album provided by a social platform, and achieving effects of automatic classification of a photo collection and automatic display of photos of a figure in a photo at each age stage.

Specifically, the foregoing embodiment is described in detail by using an example in which a parent-child album on a social platform is used as a photo collection. The parent-child album may be a photo collection used to specially store photos of a same person from birth to various growth stages, and a figure in a photo in a parent-child album may be referred to as an album baby. A user can set a birth date of an album baby corresponding to a parent-child album by using an input interface or a selection control; after a photo shooting time of each parent-child photo in the parent-child album is read, a sorting date of each photo in the current parent-child album is acquired by calculating a difference between the birth date of the album baby and the photo shooting time of each parent-child photo, and finally, the photos in the parent-child album are displayed in a timeline according to the sorting dates, so that all the photos in the parent-child album are automatically classified and displayed according to the photo shooting times of the parent-child photos, that is, classified photos of the baby at each age stage in the parent-child album are automatically presented in the timeline.

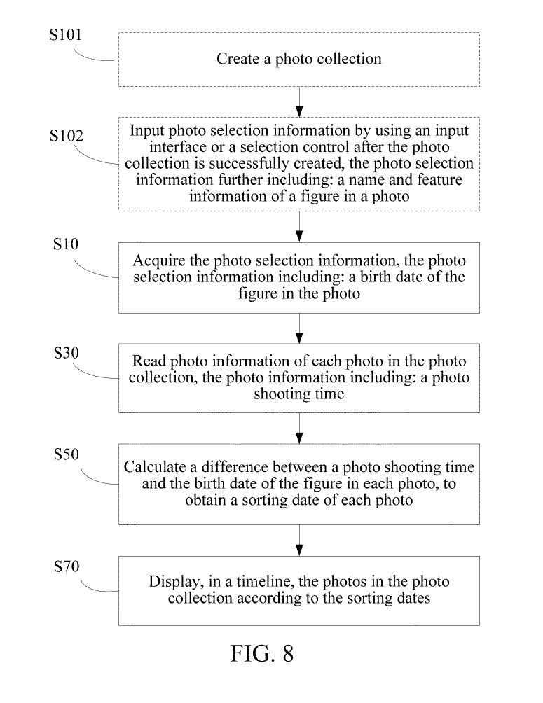

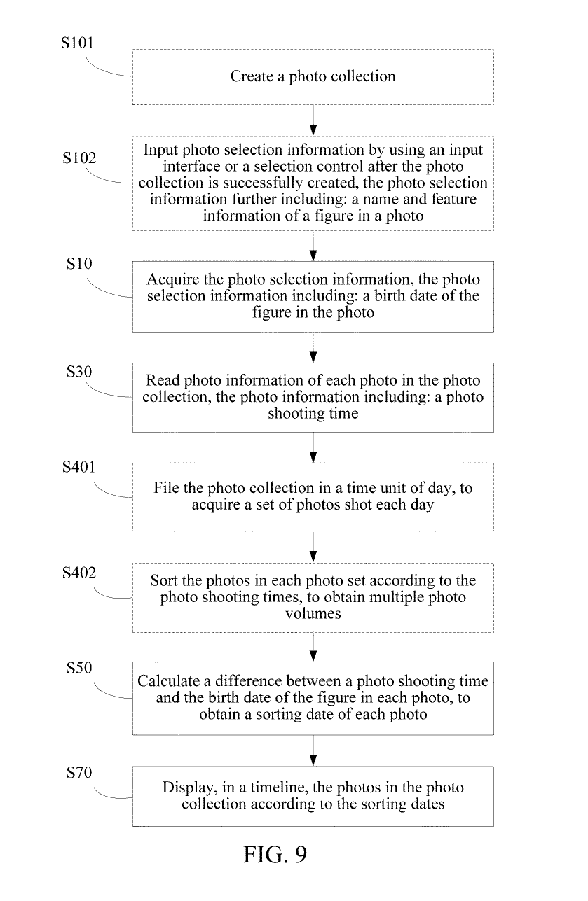

In the foregoing embodiment of this application, as shown in FIG. 8, before step S10 of acquiring photo selection information is performed, the foregoing method embodiment of this application may further include the following implementation steps:

Step S101: Create a photo collection.

Specifically, an example in which a parent-child album on a social platform is used as a photo collection is still used, and a user may create a parent-child album on a social platform, where the parent-child album is used to store photos related to the album baby.

Step S102: Input photo selection information by using an input interface or a selection control after the photo collection is successfully created, the photo selection information further including: a name and feature information of a figure in a photo.

Specifically, an example in which a parent-child album on a social platform is used as a photo collection is still used, and after the parent-child album is created, the user can edit the parent-child album, and input photo selection information of the parent-child album. For example, the user can select a birth date and time of the album baby (that is, the figure in the photo), and input information of the album baby, such as a birth weight, a childhood name, and a blood type.

It should be noted herein that the user can upload related photos of the baby to the parent-child album at any time, that is, update content of the photo collection. In addition, when the user uploads a parent-child photo, the system can extract a photo shooting time of the newly uploaded photo from EXIF information of the photo and save the photo shooting time.

In the foregoing embodiment of this application, as shown in FIG. 9, before step S50 of calculating a difference between the birth date of the figure in the photo and a photo shooting time of each photo, to obtain a sorting date of each photo, the foregoing method embodiment of this application may further include the following implementation steps:

Step S401: File the photo collection in a time unit of day, to acquire a set of photos shot each day.

Step S402: Sort the photos in each photo collection according to the photo shooting times, to obtain multiple photo volumes.

Specifically, an example in which a parent-child album on a social platform is used as a photo collection is still used. In step S401 and step S402, it is achieved that photos in the parent-child album are filed according to extracted photo shooting times, a photo collection is arranged in a unit of day, and photos in the photo collection are arranged according to the photo shooting times, thereby obtaining multiple photo volumes. In this case, shooting times of photos saved in each photo volume belong to a same day.

It should be noted herein that in this application, the photo collection may further be filed in a unit of month, week, quarter, or year as needed, to obtain photo collections that are obtained after being filed according to different time units, which is not limited in the present disclosure.

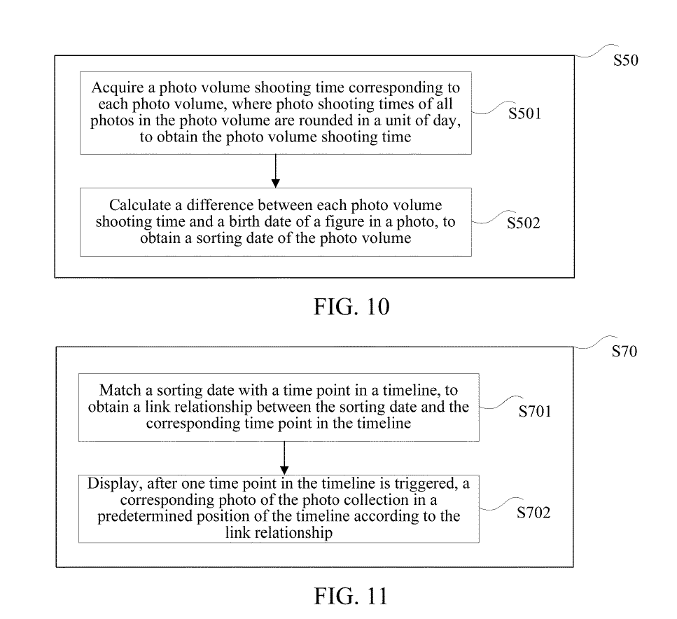

As shown in FIG. 10, in the foregoing embodiment of this application, step S50 of calculating a difference between the birth date of the figure in the photo and a photo shooting time of each photo, to obtain a sorting date of each photo may include the following implementation steps:

Step S501: Acquire a photo volume shooting time corresponding to each photo volume, where photo shooting times of all photos in the photo volume are rounded in a unit of day, to obtain the photo volume shooting time.

Specifically, in the step, the photo volume shooting time may be processed in a unit of day; a corresponding photo volume shooting time may also be acquired in a unit of week, month, quarter, or year. For example, a current photo volume includes three photos, and photo shooting times of the photos are separately: Oct. 1, 2014 8:01, Oct. 1, 2014 8:10, and Oct. 1, 2014 8:26; then the photo shooting time of each photo may be rounded in the unit of day, and a shooting time of the current photo volume is Oct. 1, 2014. As can be learned from this, photo volumes of a photo collection that have different numbers and content may be obtained in different time units, and a photo volume shooting time of each photo volume is acquired, which are not limited in the present disclosure.

Step 5502: Calculate a difference between each photo volume shooting time and the birth date of the figure in the photo, to obtain a sorting date of the photo volume.

Specifically, as described above, in the step, in addition to in a unit of day, the sorting date of the photo volume may also be in a unit of week, month, quarter, or year, so as to correspond to different time points in the timeline.

In the foregoing embodiment of this application, as shown in FIG. 11, step S70 of displaying, in a timeline, the photos in the photo collection according to the sorting dates may include the following implementation steps:

Step 5701: Match the sorting date with a time point in the timeline, to obtain a link relationship between the sorting date and the corresponding time point in the timeline.

Step 5702: Display, in a predetermined position in the timeline, the photos in the photo collection according to the link relationship after the time point in the timeline is triggered.

Specifically, an example in which a parent-child album on a social platform is used as a photo collection is still used. In step 5701 and step 5702 of this application, a difference between birth date information of a baby and a photo shooting time may also be calculated to obtain a sorting date of a photo, so that a correspondence between the sorting date and a time point of the baby photo in a timeline may be determined, and photo information of the baby from birth to various stages is presented according to the obtained correspondence.

Further, age information, birth weight information, and childhood name information of the baby may also be presented.

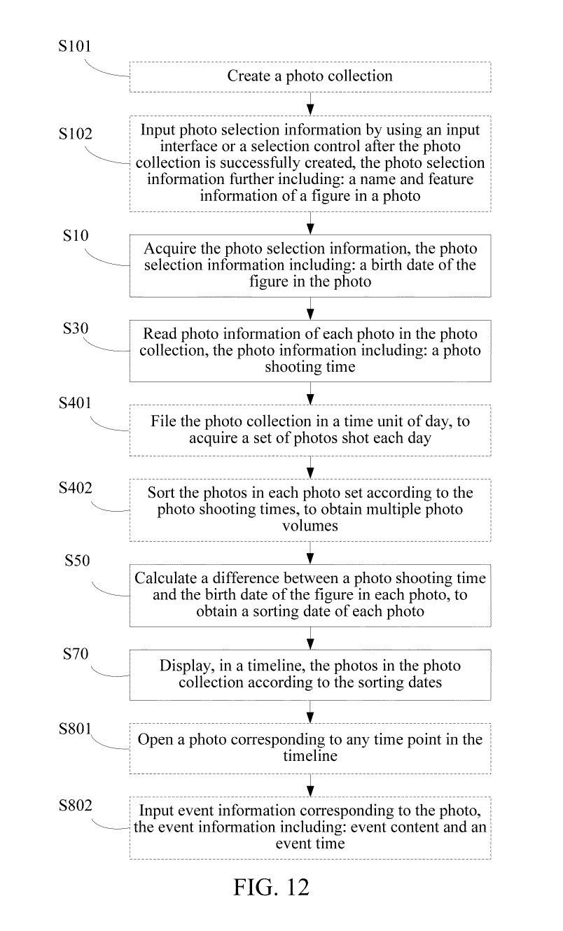

In the foregoing embodiment of this application, as shown in FIG. 12, after step S70 of displaying, in a timeline, the photos in the photo collection according to the sorting dates, the foregoing method embodiment of this application may further include the following implementation steps:

Step 5801: Open a photo corresponding to any time point in the timeline.

Specifically, an example in which a parent-child album on a social platform is used as a photo collection is still used. In the step, a user opens a parent-child album corresponding to any time point in the timeline, and photo information and ages of a baby after birth at various stages are presented.

Step S802: Input event information corresponding to the photo, the event information including: event content and an event time.

Specifically, an example in which a parent-child album on a social platform is used as a photo collection is still used. In step S802, it is achieved that a user can input, into the opened parent-child album, an event in a growth process of the baby for each photo. For example, the user records information such as event content of the baby, a time when the event occurred, and thoughts when the event occurred. Therefore, after the event information corresponding to the photo is saved, when a parent-child album is opened subsequently, in addition to presenting photos shot within a corresponding time, the system may further present event content of all photos in the parent-child album, and present times when the events occurred.

As can be learned from this, in step S801 and step S802 of this application, it is achieved that a user creates and presents an event for a photo displayed in a timeline, to record an important event of a figure in the photo occurred at a particular time, such as an event and thought when a baby was born, one-month old, or one-year old, or may be another event deemed to be meaningful. The event is edited based on a particular time corresponding to the figure in the photo in the timeline, so that description of the event, a time when the event occurred, the age of the baby when the event occurred, and the photo shot when the event occurred can be collectively presented according to event description of the baby input by the user, and input and presentation of a childhood name and a birth weight of the baby of the parent-child album that are edited by the user can also be provided.

To sum up, the present disclosure provides a photo collection display method, in which photos can be automatically classified and sorted according to times when a user shot the photos and birth dates of figures in the photos, and photos of the figures in the photos at various age stage can be presented; an interface through which the user can turn to an event (major event) of the figure in the photo that occurred at a particular time is provided, and the event of the figure in the photo and a scenario of the photo when the event occurred can be displayed; and a childhood name and birth weight of the figure in the photo can be presented according to input of the user. The present disclosure provides a method for managing photos of a user from birth to various growth stages, which is used for the user to create a parent-child album, and manage and view photos of growth of a figure in a photo (a baby) at various age stages and corresponding major events.

In the foregoing method embodiment, not only can a newly created photo collection be processed, but also an existing photo album can be converted into a parent-child album. It should be further noted that the foregoing method embodiment is not limitedly applied to a parent-child photo collection on an Internet social platform, but also can be applied to filing and arrangement of any Internet photos or any local photos on a terminal, and any type of photo collection, such a travel photo collection, or a documentary photo collection.

It should be noted that the foregoing method embodiments are all described as a series of action combinations for ease of description. However, it should be noted by a person skilled in the art that the present disclosure is not limited by the sequence of the described actions, because according to the present disclosure, some steps may be performed in another order or simultaneously. Second, it should also be noted by a person skilled in the art that the embodiments described in the specification are all preferred embodiments, and the actions and modules involved therein are not necessarily needed by the present disclosure.

Based on the foregoing description of the implementation manners, a person skilled in the art may clearly understand that the methods of the foregoing embodiments may be implemented by software in addition to a necessary universal hardware platform or by hardware, but the former is a better implementation manner in most cases. Based on such an understanding, the technical solutions of the present disclosure essentially, or the part contributing to the existing technology may be implemented in a form of a software product. The computer software product is stored in a storage medium (such as a ROM/RAM, a magnetic disk, or an optical disc) and includes several instructions for instructing a terminal device (which may be a mobile phone, a computer, a server, a network device, or the like) to perform the methods described in the embodiments of the present invention.

It should be further described herein that functional modules in the apparatus embodiment provided in Embodiment 1 correspond to steps of the method embodiment in Embodiment 2, and examples and application scenarios implemented by the modules and the corresponding steps are the same, but not limited to the content disclosed in the foregoing embodiments. It should be noted that the apparatus modules as a part of the apparatuses may be operated on a client terminal, and may be implemented by software or by hardware.

It can be seen from the foregoing description that the present disclosure achieves the following technical effects: A condition for arranging photos in a photo collection is acquired by using a birth date of a figure in a photo and a photo shooting time of each photo, to determine a display order of the photos, and in this case, a system displays the photos in a timeline by using sorting dates obtained through calculation, that is, it is defined that each photo is automatically classified according to the sorting date. so that when a user views the photo collection, the photos displayed in the timeline can provide the user with a function of viewing the photos and the photo shooting times in batches, and the user can learn a corresponding age stage of the figure in the photo when the photo was shot, that is, a function of automatic management and classification for the figure in the photo is provided, thereby solving the technical problem in the related technology of disordered display and poor user experience that are caused by unorganized photos in a photo album provided by a social platform, and achieving effects of automatic classification of a photo collection and automatic display of photos of a figure in a photo at each age stage.

The sequence numbers of the foregoing embodiments of the present invention are merely for the convenience of description, and do not imply the preference among the embodiments.

In the foregoing embodiments of the present invention, each embodiment is described with particular emphasis, and for a part not described in detail in an embodiment, reference may be made to related description of other embodiments.

In the several embodiments provided in this application, it should be understood that the disclosed client may be implemented in other manners. The described apparatus embodiments are merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electronic, or other forms.

The units described as separate parts may or may not be physically separate, and the parts displayed as units may or may not be physical units, that is, may be located in one position, or may be distributed on multiple network units. Some or all of the units may be selected according to actual needs to achieve the objectives of the solutions of the embodiments.

In addition, the functional units in the embodiments of the present invention may be integrated into one processing unit, or each of the units may exist alone physically, or two or more units may be integrated into one unit. The integrated unit may be implemented in a form of hardware, or may be implemented in a form of a software functional unit.

If the integrated unit is implemented in a form of a software functional unit and sold or used as an independent product, the integrated unit may be stored in a computer-readable storage medium. Based on such an understanding, the technical solutions of the present disclosure essentially, or the part contributing to the existing technology, or all or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present invention. The foregoing storage medium includes: any medium that can store program code, such as a USB flash drive, a read-only memory (ROM), a random access memory (RAM), a removable hard disk, a magnetic disk, or an optical disc.

The foregoing descriptions are merely preferred implementation manners of the present disclosure. It should be noted that a person of ordinary skill in the art may further make some improvements and modifications without departing from the principles of the present disclosure, and these improvements and modifications should also be construed as falling within the protection scope of the present disclosure.

What is claimed is:

1. A photo collection display method, comprising:
at a computing device having one or more processors and memory storing programs executed by the one or more processors:
acquiring photo selection information, the photo selection information comprising: a birth date of a figure in a photo;
reading photo information of each photo in a photo collection, the photo information comprising: a photo shooting time, the photo collection recording more than one photo;
calculating a difference between a photo shooting time and the birth date of the figure in each photo, to obtain a sorting date of each photo;
creating a timeline comprising time points;
matching the sorting date with a time point in the timeline, to obtain a link relationship between the sorting date and the corresponding time point in the timeline; and
displaying, after one time point in the timeline is triggered, a corresponding photo of the photo collection in a predetermined position of the timeline according to the link relationship.

2. The method according to claim 1, wherein before the acquiring photo selection information, the method further comprises:
creating the photo collection; and
inputting the photo selection information by using an input interface or a selection control after the photo collection is successfully created, wherein the photo selection information further comprises: a name and feature information of the figure in the photo.

3. The method according to claim 1, wherein before calculating a difference between a photo shooting time and the birth date of the figure in each photo, to obtain a sorting date of each photo, the method further comprises:
filing the photo collection in a time unit of day, to acquire a set of photos shot each day; and
sorting the photos in each photo collection according to the photo shooting times, to obtain multiple photo volumes.

4. The method according to claim 3, wherein the step of calculating a difference between the birth date of the figure in the photo and a photo shooting time of each photo, to obtain a sorting date of each photo comprises:
acquiring a photo volume shooting time corresponding to each photo volume, wherein photo shooting times of all photos in the photo volume are rounded in a unit of day, to obtain the photo volume shooting time; and
calculating a difference between each photo volume shooting time and the birth date of the figure in the photo, to obtain a sorting date of the photo volume.

5. The method according to claim 1, wherein after displaying, after one time point in the timeline is triggered, a corresponding photo of the photo collection in a predetermined position of the timeline according to the link relationship, the method further comprises:
opening a photo corresponding to any time point in the timeline; and
inputting event information corresponding to the photo, wherein the event information comprises: event content and an event time.

6. A photo collection display apparatus, comprising a plurality of program modules comprising computer-implemented instructions stored in memory of a computing device and executed by one or more processors of the computing device, the plurality program modules comprising:
an acquisition module, configured to acquire photo selection information, the photo selection information comprising: a birth date of a figure in a photo;
a read module, configured to read photo information of each photo in a photo collection, the photo information comprising: a photo shooting time, the photo collection recording more than one photo;
a processing module, configured to calculate a difference between a photo shooting time and the birth date of the figure in each photo, to obtain a sorting date of each photo; and
a display processing module, configured to display, in a timeline, the photos in the photo collection according to the sorting dates, the display processing module comprising a matching unit and a display unit:
the matching unit being configured to match the sorting date with a time point the timeline, to obtain a link relationship between the sorting date and the corresponding time point in the timeline, to obtain a link relationship between the sorting date and the corresponding time point in the timeline; and
the display unit being configured to display, after one time point in the timeline is triggered, a corresponding photo of the photo collection in a predetermined position of the timeline according to the link relationship.

7. The apparatus according to claim 6, wherein the apparatus further comprises:
a creation module, configured to create the photo collection; and
an editing module, configured to input the photo selection information by using an input interface or a selection control after the photo collection is successfully created, wherein the photo selection information further comprises: a name and feature information of the figure in the photo.

8. The apparatus according to claim 6, wherein the apparatus further comprises:
a filing processing module, configured to file the photo collection in a time unit of day, to acquire a set of photos shot each day; and
a sorting module, configured to sort the photos in each photo collection according to the photo shooting times, to obtain multiple photo volumes.

9. The apparatus according to claim 8, wherein the processing module comprises:
an acquisition submodule, configured to acquire a photo volume shooting time corresponding to each photo volume, wherein photo shooting times of all photos in the photo volume are rounded in a unit of day, to obtain the photo volume shooting time; and
a calculation submodule, configured to calculate a difference between each photo volume shooting time and the birth date of the figure in the photo, to obtain a sorting date of the photo volume.

10. A non-transitory computer readable storage medium having stored therein one or more instructions, which, when executed by a computing device, cause the computing device to:
acquire photo selection information, the photo selection information comprising: a birth date of a figure in a photo;
read photo information of each photo in a photo collection, the photo information comprising:
a photo shooting time, the photo collection recording more than one photo;
calculate a difference between a photo shooting time and the birth date of the figure in each photo, to obtain a sorting date of each photo;
match the sorting date with a time point in the timeline, to obtain a link relationship between the sorting date and the corresponding time point in the timeline; and
display, after one time point in the timeline is triggered, a corresponding photo of the photo collection in a predetermined position of the timeline according to the link relationship.

11. The non-transitory computer readable storage medium according to claim 10, further comprising instructions to:
create the photo collection; and
input the photo selection information by using an input interface or a selection control after the photo collection is successfully created, wherein the photo selection information further comprises:
a name and feature information of the figure in the photo.

12. The non-transitory computer readable storage medium according to claim 10, further comprising instructions to:
file the photo collection in a time unit of day, to acquire a set of photos shot each day; and
sort the photos in each photo collection according to the photo shooting times, to obtain multiple photo volumes.

13. The non-transitory computer readable storage medium according to claim 12, wherein the calculating a difference between the birth date of the figure in the photo and a photo shooting time of each photo, to obtain a sorting date of each photo, comprises:
acquire a photo volume shooting time corresponding to each photo volume, wherein photo shooting times of all photos in the photo volume are rounded in a unit of day, to obtain the photo volume shooting time; and
calculate a difference between each photo volume shooting time and the birth date of the figure in the photo, to obtain a sorting date of the photo volume.

14. The non-transitory computer readable storage medium according to claim 10, further comprising instructions to:
open a photo corresponding to any time point in the timeline; and
input event information corresponding to the photo, wherein the event information comprises:
event content and an event time.
